(19) United States
(12) Patent Application Publication
(10) Pub. No.: US 2006/0064918 A1
(43) Pub. Date: Mar. 30, 2006

(54) Automatic fishing device

(76) Inventor: Edward N. Schnur, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/952,956

(22) Filed: Sep. 29, 2004

(51) Int. Cl. A01K 91/10

(52) U.S. Cl. 43/15

(57) ABSTRACT

An automatic fishhook setting device having a main body portion, fishing pole retention latch and a strike sensor arm. The fishing pole retention latch has an abutment surface and is pivotally attached to the main body portion. The strike sensor arm is pivotally attached to the main body portion and has an abutment surface and a fishing line holder. The abutment surface of strike sensor arm and the abutment surface of the fishing pole retention latch cooperate to prevent the fishing pole retention latch from pivoting in at least one direction when the strike sensor arm is located in a first position. The abutment surfaces do not cooperate to prevent rotation of the fishing pole retention latch when the strike sensor arm is in a second position.

### FIELD OF THE INVENTION

The invention relates to automatic fishing devices. More specifically, the invention relates to an automatic hook setting device for a fishing pole.

### BACKGROUND OF THE INVENTION

Automatic fishing devices have been in common usage for many years. These devices typically set a hook in the mouth of a fish and may also notify the fisherman that a fish has taken the bait. Some of these devices may be used for fair weather, some may be used on a frozen lake, and others be used in both environments. Many of these devices are unduly complicated and/or work poorly and, consequently, are infrequently used by fishermen.

While these prior devices, at first appearance, have similarities to the present invention, they differ in material respects. These differences will be readily understood by one of ordinary skill in the art after viewing the detailed description of the preferred embodiment, below, and are important for the effective use of the invention to achieve its advantages.

### SUMMARY OF THE INVENTION

An automatic fishhook setting device having a main body portion, fishing pole retention latch and a strike sensor arm. The fishing pole retention latch has an abutment surface and is pivotally attached to the main body portion. The strike sensor arm is pivotally attached to the main body portion and has an abutment surface and a fishing line holder. The abutment surface of strike sensor arm and the abutment surface of the fishing pole retention latch cooperate to prevent the fishing pole retention latch from pivoting in at least one direction when the strike sensor arm is located in a first position. The abutment surfaces do not cooperate to prevent rotation of the fishing pole retention latch when the strike sensor arm is in a second position.

### BRIEF DESCRIPTION OF THE DRAWINGS

FIG. 1 is a plan view of an automatic fishhook setting device according to an embodiment of the present invention;

FIG. 2 is a side view of an automatic fishhook setting device according to an embodiment of the present invention;

FIG. 3 is a plan view of a strike sensor arm according to an embodiment of the present invention;

FIG. 4 is a side view of a strike sensor arm according to an embodiment of the present invention;

FIG. 5 is a plan view of a fishing pole retention latch according to an embodiment of the present invention;

FIG. 6 is a side view of a fishing pole retention latch according to an embodiment of the present invention;

FIG. 7 is a plan view of an automatic fishhook setting device according to an embodiment of the present invention showing the relative positions of the first and second abutment surfaces of the strike sensor arm and the fishing pole retention latch when the device is in a fish strike sensing state;

FIG. 8 is a plan view of an automatic fishhook setting device according to an embodiment of the present invention showing the relative positions of the first and second abutment surfaces of the strike sensor arm and the fishing pole retention latch when the device is in a triggered state;

FIG. 9 is a plan view of an automatic fishhook setting device in use with a fishing pole in a fish strike sensing state according to an embodiment of the present invention; and

FIG. 10 is a plan view of an automatic fishhook setting device in use with a fishing pole in a triggered state according to an embodiment of the present invention.

### DESCRIPTION OF THE PREFERRED EMBODIMENT

There is shown in the drawings and will herein be described in detail the preferred embodiment of the invention with the understanding that the present disclosure is to be considered as an exemplification of the principles of the invention.

This invention is susceptible of embodiment in many different forms and the description of the preferred embodiment and the drawings are not intended to, nor could they, show every variation of the preferred embodiment that is covered by the attached claims.

The present detailed description and drawings are therefore not intended to limit the broad, commonly accepted meanings of words unless it is explicitly stated below that a term is being redefined or limited.

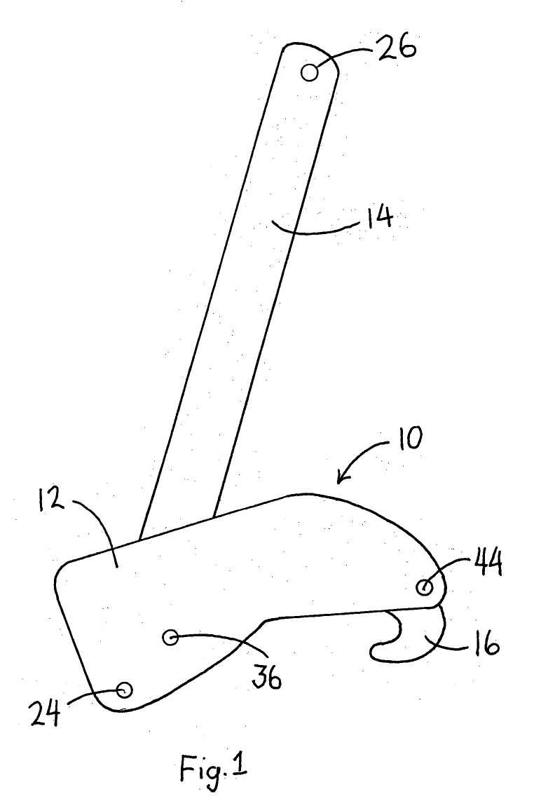

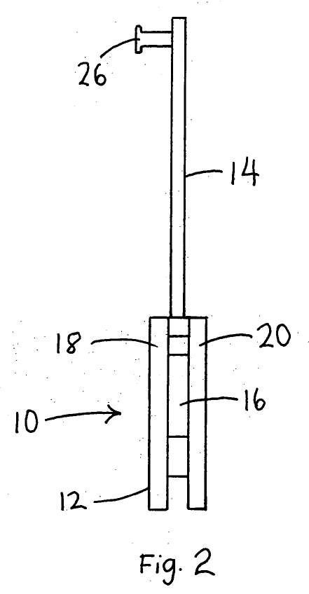

Referring to FIGS. 1 and 2, the present invention is an improved fishhook setting apparatus 10. The apparatus generally comprises a main body portion 12, a strike sensor arm 14 and a fishing pole attachment latch 16. The main body portion 12 comprises a first side 18 and a second side 20 attached to one another and spaced apart from one another. Spacers may be sandwiched between the first and second side 18, 20 to provide clearance between the first and second side 18, 20 to allow the strike arm sensor 14 and the fishing pole attachment latch 16 to be pivotally supported therebetween. The first and second sides 18, 20 are attached to one another by pins. The main body portion 12 further comprises a ground attachment 24 to which a string or line 25 may be attached.

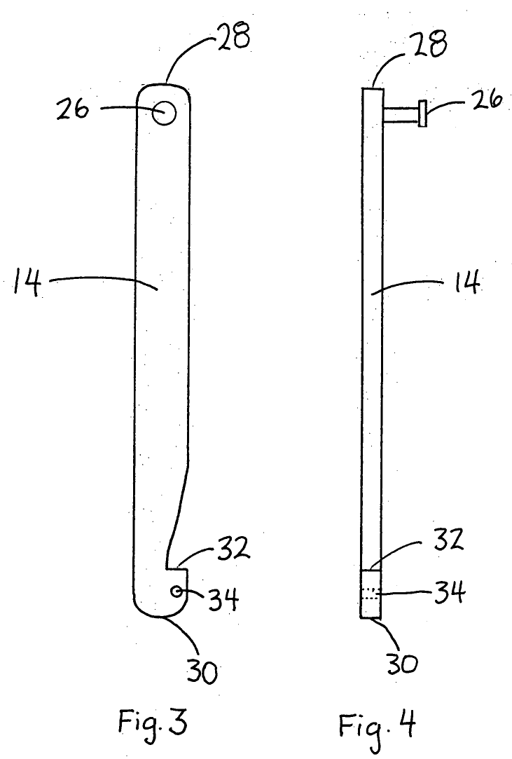

The strike sensor arm 14 is shown in FIGS. 3 and 4 removed from the main body portion 12. The strike sensor arm 14 comprises an elongate arm having a fishing line holder preferably comprising perpendicularly extending fishing line sensing pin 26 at one end 28 thereof. At an opposite end 30, the strike sensor arm 14 comprises a first abutment surface 32 and a bore 34. The strike sensor arm 14 is attached to the main body portion 12 by a pin 36 (FIG. 1) about which the strike sensor arm 14 may pivot.

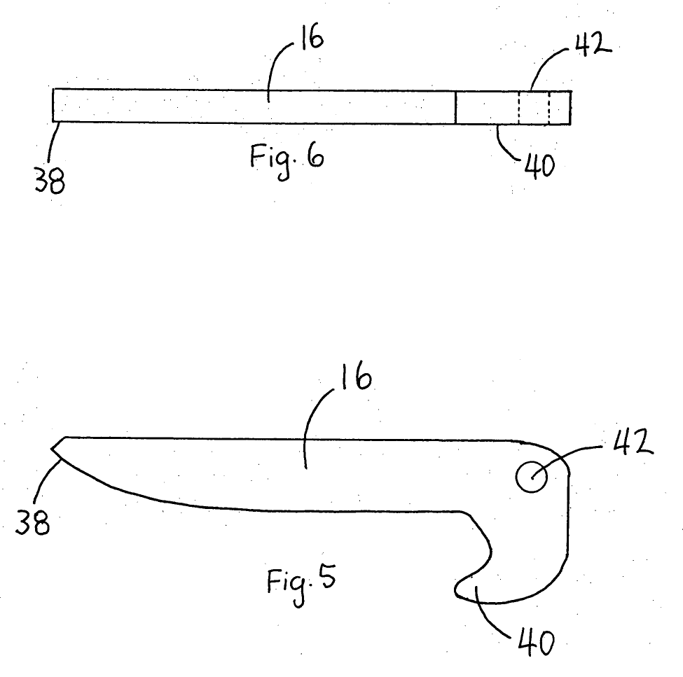

Referring to FIGS. 5 and 6, the fishing pole attachment latch 16 comprises a second abutment surface 38 and a fishing pole retention portion 40. A bore 42 is also located in the fishing pole attachment latch 16 through which a pin 44 (FIG. 1) is located in order to pivotally attach the fishing pole attachment latch 16 to the main body portion 12.

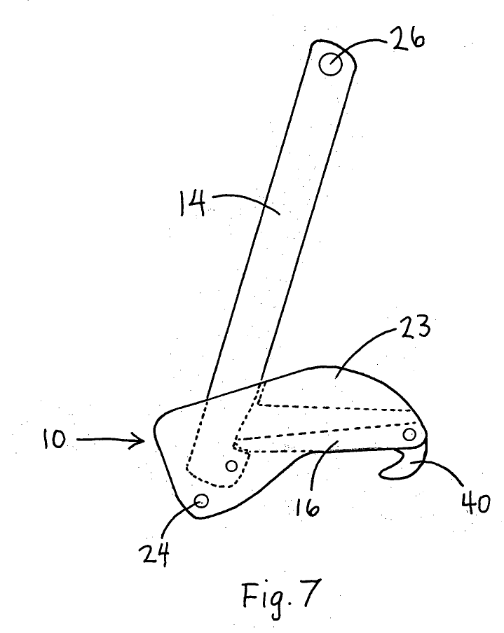

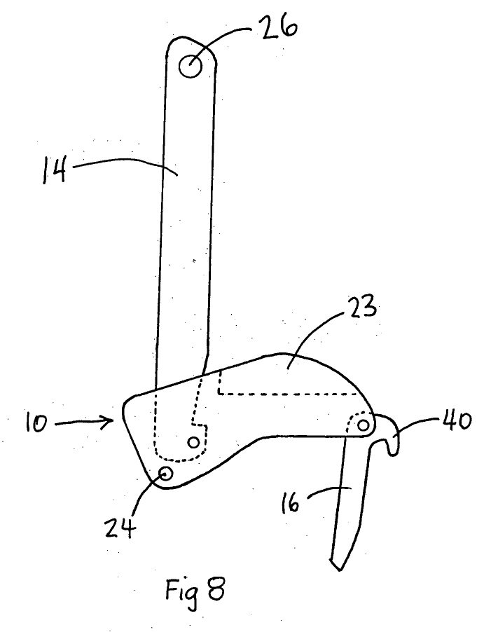

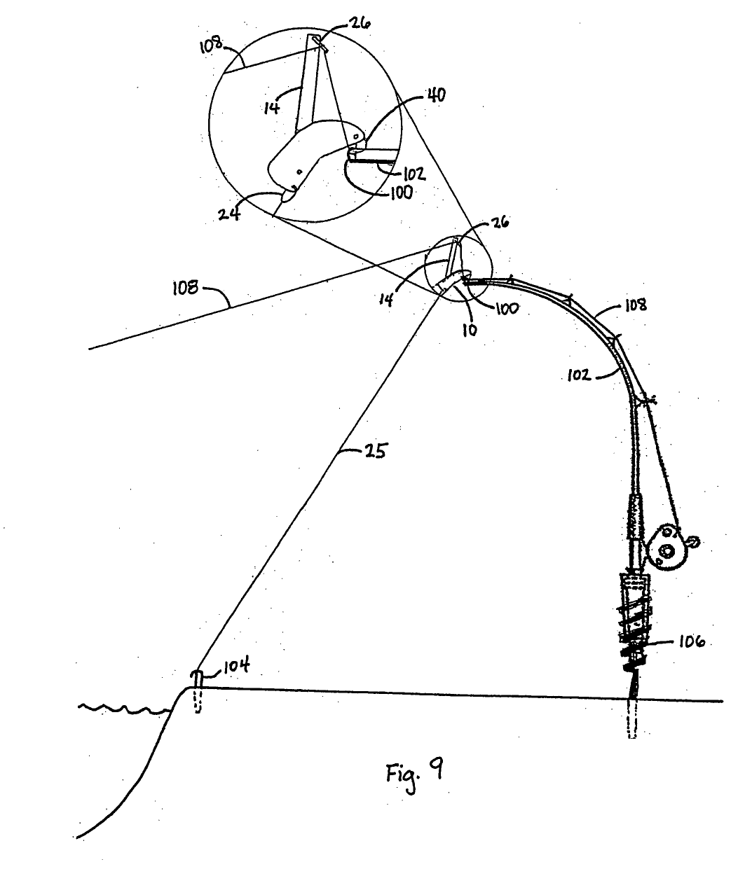

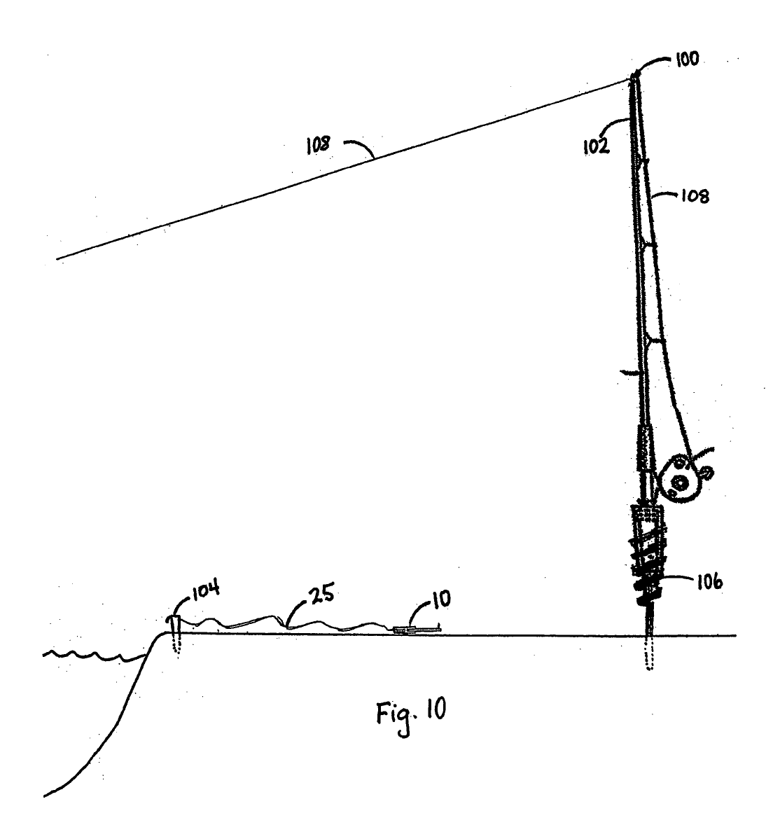

FIGS. 7 and 8 show the relative positions of the strike sensor arm 14 and the fishing pole attachment latch 16 in the fish strike sensing state (FIG. 7) where the apparatus 10 is waiting for a fish to strike a hook, lure, bait or jig (hereinafter referred to generally as a “hook”) and a triggered state (FIG. 8) where the apparatus has sensed a striking fish and has triggered a fishing pole 102 to set the hook.

Referring to FIGS. 7 and 9, when the apparatus 10 is in the fish strike sensing state, it is attached to an eye 100 of a fishing pole 102 by inserting the fishing pole retention portion 40 into the eye 100. The fishing pole 102 is then torqued as shown in FIG. 9 and a line or string is attached to the ground attachment 24 and a ground stake 104 or other fixed point by the line 25. The fishing pole 102 is placed into a standard fishing pole holder 106 that has also been driven into the ground or otherwise attached to a fixed point. It is also contemplated that the line 25 could be attached to the fishing pole holder 106 rather than the ground stake 104, although the manner of attaching the line to the earth or other solid object should not limit the present invention.

The fishing line 108 is then placed over the fishing line sensing pin 26. In this position, and with reference to FIG. 5 specifically, the torque of the fishing pole 102 has the effect of rotating the fishing pole attachment latch 16 counterclockwise. The second abutment surface 38 of the fishing pole attachment latch 16 then contacts the first abutment surface 32 of the strike sensor arm 14 (FIG. 3). This has the effect of rotating the strike sensor arm 14 clockwise. A strike sensor arm housing spacer 23 limits movement of the strike sensor arm 14 so that the strike sensor arm 14 abuts the housing spacer 23. In this manner, the fishing pole 102 is maintained in the torqued position by the apparatus 10.

When a fish strikes the hook at the end of the fishing line 108, the fish will cause the fishing line 108 to become taut. The tightened line 108 will pull the strike sensor arm 14 counterclockwise. After the strike sensor arm 14 has rotated sufficiently counterclockwise, the first abutment surface 32 of the strike sensor arm 14 will slide past the second abutment surface 38 of the fishing pole attachment latch 16. When first abutment surface 32 of the strike sensor arm 14 slides past the second abutment surface 38 of the fishing pole attachment latch 16, there is no longer a counteracting force preventing the fishing pole 102 from rotating the fishing pole attachment latch 16 counterclockwise. As the fishing pole attachment latch 16 rotates counterclockwise, the fishing pole retention portion 40 no longer holds the eye 100 of the fishing pole 102 and the fishing pole 102 is allowed to snap back its original straight-line orientation, thereby snapping the fishing line 108 back and providing the force to set the hook within the mouth of the fish taking the bait. The apparatus 10 then falls to the ground or into the water completely unattached to the fishing pole 102 so as to prevent any interference with the fisherman reeling in the fish.

It is contemplated that the present device can be made from cast or machined aluminum or molded from a polymer material. Additionally, if made from a polymer material, the pins may be made from a metal and molded or inserted into the molded polymer or the pins may also be molded from the polymer material. If the pins are molded from a polymer material they mold be permanently attached to only one side of the main body portion so that the main body portion may be resiliently deformed to allowed the strike sensor arm and the fishing pole retention latch to be assembled to the main body portion. However, the specific material used is not an element of the present invention and does not limit the scope of the invention.

While a specific embodiment has been illustrated and described, numerous modifications come to mind without significantly departing from the spirit of the invention, and the scope of protection is only limited by the scope of the accompanying claims.

I claim:

1. An automatic fish hook setting device comprising:
a main body portion;
a fishing pole retention latch having an abutment surface and being pivotally attached to the main body portion; and
a strike sensor arm pivotally attached to the main body portion, having an abutment surface and comprising a fishing line holder, the abutment surface of strike sensor arm and the abutment surface of the fishing pole retention latch cooperating to prevent the fishing pole retention latch from pivoting in at least one direction when the strike sensor arm is located in a first position and the abutment surfaces not cooperating to prevent rotation of the fishing pole retention latch when the strike sensor arm is in a second position.

2. The automatic fish hook setting device of claim 1 wherein the fishing line holder is a pin extending perpendicularly from the strike sensor arm.

3. The automatic fish hook setting device of claim 1 wherein the fishing pole retention latch further comprises a fishing pole retention portion.

4. The automatic fish hook setting device of claim 1 wherein the main body portion comprises a first side and a second side attached to and spaced apart from one another.

5. The automatic fish hook setting device of claim 1 further comprising a strike sensor arm housing spacer that limits the pivotal travel the strike sensor arm.

6. The automatic fish hook setting device of claim 1 wherein the main body portion is made from a molded polymer material.

7. The automatic fish hook setting device of claim 6 wherein the strike sensor arm and the fishing pole retention latch are made from a molded polymer material.

8. An automatic fish hook setting device comprising:
a main body portion;
a fishing pole retention latch having an abutment surface and a protuberance adapted to extend through the eyelet of a fishing pole to retain the fishing pole in a torqued position, the latch being pivotally attached to the main body portion; and
a strike sensor arm pivotally attached to the main body portion, having an abutment surface and comprising a fishing line holder, the abutment surface of strike sensor arm and the abutment surface of the fishing pole retention latch cooperating to prevent the fishing pole retention latch from pivoting in at least one direction when the strike sensor arm is located in a first position and the abutment surfaces not cooperating to prevent rotation of the fishing pole retention latch when the strike sensor arm is in a second position.

9. The automatic fish hook setting device of claim 8 wherein the fishing line holder is a pin extending perpendicularly from the strike sensor arm.

10. The automatic fish hook setting device of claim 8 wherein the main body portion comprises a first side and a second side attached to and spaced apart from one another.

11. The automatic fish hook setting device of claim 8 further comprising a strike sensor arm housing spacer that limits the pivotal travel the strike sensor arm.

12. The automatic fish hook setting device of claim 8 wherein the main body portion is made from a molded polymer material.

13. The automatic fish hook setting device of claim 12 wherein the strike sensor arm and the fishing pole retention latch are made from a molded polymer material.

14. A method of automatically setting a fishhook comprising:
mounting a resilient fishing pole to a fixed point;
attaching a retention line to a fixed point and body portion attached to a strike sensor arm;
torquing the resilient fishing pole from its resting orientation;
attaching an end of the fishing pole to a fishing pole attachment latch; and
joining a fishing line of the fishing pole to the strike sensor arm such that when the fishing line becomes taut, the strike sensor arm causes the fishing pole attachment latch to allow the fishing pole to resiliently snap back to its resting orientation and pull the fishing line to set a hook within a fish's mouth.

15. The device of claim 14 further comprising the step of completely releasing the fishing pole such that a fisherman is unimpeded from using the fishing pole by any attachment of the fishing pole retention latch, the strike sensor are or the retention line.
